(19) United States
(12) Patent Application Publication
(10) Pub. No.: US 2004/0184467 A1
(43) Pub. Date: Sep. 23, 2004

(54) Gateway apparatus and IPv6 network system

(75) Inventor: Koichi Watanabe, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/392,884

(22) Filed: Mar. 21, 2003

(51) Int. Cl. H04L 12/28

(52) U.S. Cl. 370/401; 370/395.52

(57) ABSTRACT

An IPv6 network system according to one aspect of this invention makes filtering upon IP packet transfer and limits functions of generic services in accordance with the value of an interface ID, which is contained in an IP address of an IPv6 packet of, e.g., an MFP apparatus connected to an IPv6 network, and is unique to the apparatus, in a plurality of IPv6 networks connected via routers and firewalls as gateway apparatuses. In this way, security control is implemented upon connecting the networks. Since the interface ID contains information indicating communication contents and an attribute of a device, communication control is implemented in accordance with the attribute.

### BACKGROUND OF THE INVENTION

In general, the IPv4 address has a length of 32 bits, and addresses assigned to a given network are distributed to hosts. Hence, an identical address is not always distributed to one host. When a host is connected to another network, its address changes inevitably.

Under the circumstance, when packet filtering is implemented based on IP addresses contained in transfer packets upon transferring data among different networks connected via a gateway, a gateway apparatus must always recognize correspondence of IP addresses of hosts to be filtered. Hence, attributes such as control of permission, inhibition, and the like for respective device types cannot be uniquely specified from assigned IP addresses. For this reason, control setups must be done for respective IP addresses corresponding in number to hosts, setup works increase, and the processing load becomes heavier with increasing number of hosts that require filtering. Note that packet filtering means control of permission/inhibition of transfer on the basis of IP addresses.

For example, the Internet or the like uses identifiers (MAC addresses) unique to devices so as to identify nodes within an identical link. However, the Internet or the like does not use any identifiers unique to devices which serve as two end points of communications upon making IP communications between different networks connected via a router and gateway.

By contrast, the IPv6 address has a length of 128 bits. A network address can be assigned to the former 64 bits, and an interface ID can be assigned to the latter 64 bits. Hence, the interface ID of a given host remains unchanged independently of the networks to which the host is connected. Note that the interface ID means a global unique value for a host.

### BRIEF SUMMARY OF THE INVENTION

The present invention has been made in consideration of the aforementioned problems, and has as its object to reduce the load on filtering by adding an IP packet filtering function to a router in terms of security, and to simplify setups required for filtering so as to reduce the load on management works.

According to the first aspect of the present invention, there is provided a gateway apparatus which identifies source and destination addresses in an IPv6 header of an IP packet upon transferring an IP packet between networks, and controls, when interface IDs in the source and destination addresses match a pre-set condition, permission/inhibition of transfer between the networks, which are determined in correspondence with the condition.

According to the second aspect of the present invention, there is provided an IPv6 network system comprising an apparatus which is connected to an IPv6 network and has an IPv6 address, and a gateway apparatus which identifies source and destination addresses in an IPv6 header of an IP packet upon transferring an IP packet between networks, and controls, when interface IDs in the source and destination addresses match a pre-set condition, permission/inhibition of transfer between the networks, which are determined in correspondence with the condition.

According to the third aspect of the present invention, there is provided an IPv6 network system comprising an apparatus which is connected to an IPv6 network and has an IPv6 address, in which an interface ID contains class information, that indicates a type of that apparatus, a type of communication contents, and the like, independently of information used to individually identify the apparatus, a gateway apparatus for connecting a plurality of IPv6 networks, and a server which identifies source and destination addresses in an IPv6 header of an IP packet upon generation of a service request from the apparatus using the IP packet, and controls, when class information in the interface IDs in the source and destination addresses match a pre-set condition, a change in function to a service corresponding to the condition or permission/inhibition of the service.

According to the fourth aspect of the present invention, there is provided an IPv6 network system comprising an apparatus which is connected to an IPv6 network and has an IPv6 address, in which an interface ID contains class information, that indicates a type of that apparatus, a type of communication contents, and the like, independently of information used to individually identify the apparatus, a gateway apparatus for connecting a plurality of IPv6 networks, and a server which identifies a source address in an IPv6 header of an IP packet upon generation of a service request from the apparatus using the IP packet, and dynamically switches service contents in accordance with interface ID information in the source address.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below serve to explain the principles of the invention.

FIG. 1 is a schematic diagram of an IPv6 network system according to the first embodiment of the present invention;

FIG. 2 shows the structure of an IPv6 packet header;

FIG. 3 shows the address structure of an IPv6 aggregatable global unicast address (RFC2374);

FIG. 4 is a view for explaining a process for generating an interface ID from EUI-64ID;

FIG. 5 is a view for explaining a process for generating an interface ID from IEEE802 (Ethernet) 48-bit MAC;

FIG. 6 is a diagram showing the connection relationship among various devices 24 and 25 on a user network, and a maintenance information acquisition server 26 on a network of a maintenance service provider via an Internet 21;

FIG. 7 shows an example of a filtering setup table;

FIG. 8 shows an example wherein some bits of a vender supply ID (device identifier) of an interface ID are used as a class ID;

FIG. 9A shows layers of the class ID, FIG. 9B shows details of respective classes, and FIG. 9C shows details of a communication range;

FIG. 10 is a diagram for explaining, in detail, a use method which adopts the interface ID as a use condition for generic services in the first embodiment;

FIG. 11 is a block diagram of an IPv6 network system according to the second embodiment of the present invention;

FIG. 12 is a block diagram of an IPv6 network system according to the third embodiment of the present invention; and

FIG. 13 is a block diagram of an IPv6 network system according to the fourth embodiment of the present invention.

### DETAILED DESCRIPTION OF THE INVENTION

Preferred embodiments of the present invention will be described in detail hereinafter with reference to the accompanying drawings.

(First Embodiment)

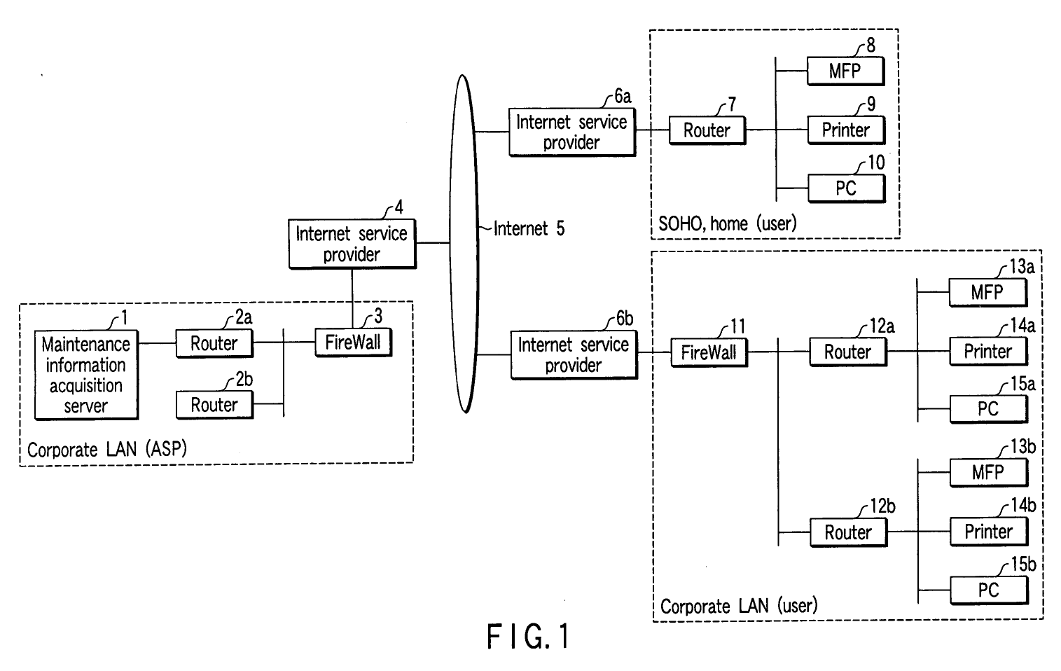

FIG. 1 is a schematic diagram of an IPv6 network system according to the first embodiment of the present invention, and the arrangement and operation of that network system will be described in detail below.

As shown in FIG. 1, a multi-function peripheral apparatus (to be referred to as an MFP apparatus hereinafter) 8, printer 9, and personal computer (to be referred to as a PC hereinafter) 10 in a SOHO or home network are connected to a server 6a of an Internet service provider via a router 7. The MFP apparatus 8 and the like make external communications via an Internet 5 by an Internet connection service provided by the server 6a of the Internet service provider. The MFP apparatus means a hybrid apparatus or the like which integrates, e.g., printer, facsimile, and copy functions.

An MFP apparatus 13a, printer 14a, and PC 15a in a network of a corporate LAN are connected to a server 6b of an Internet service provider via a router 12a and firewall 11. An MFP apparatus 13b, printer 14b, and PC 15b in another network of the corporate LAN are connected to the server 6b of the Internet service provider via a router 12b and the firewall 11. The MFP apparatus 13a and the like make external communications via the Internet 5 by an Internet connection service provided by the server 6b of the Internet service provider.

The reason why the MFP apparatus 8 and the like are connected to the servers 6a and 6b of the Internet service providers via the routers 7, 12a, and 12b and firewall 11 is to assure security of LANs including the SOHO or home LAN, corporate intranet, and the like, and to prevent communication packets from inadvertently flowing out to/in from the Internet 5. Also, when the LAN scale is large like in the corporate LAN, and there are a plurality of networks, these networks are connected via the routers 12a and 12b for the same purpose.

In this IPv6 network system, a maintenance information acquisition server 1 monitors the operating states and expendables of the MFP apparatuses and the like, and acquires maintenance information of a setup assistant and the like. Then, services suited to the users are quickly provided. The maintenance information acquisition server 1 is connected to a server 4 of an Internet service provider via a router 2a and firewall 3.

In this way, the IPv6 network system according to the first embodiment uses the interface IDs of IPv6 addresses upon acquiring information of only devices which are connected to the LANs and are to undergo remote maintenance via the Internet. That is, only communication data of a target device is selectively passed using the interface ID, thus assuring security. In order to implement such process, an IP packet filtering function is added to each router to reduce the load on filtering, and setups required for filtering are simplified to reduce the load on management works.

An outline of an IPv6 address that the IPv6 network system according to the first embodiment of the present invention adopts will be described below.

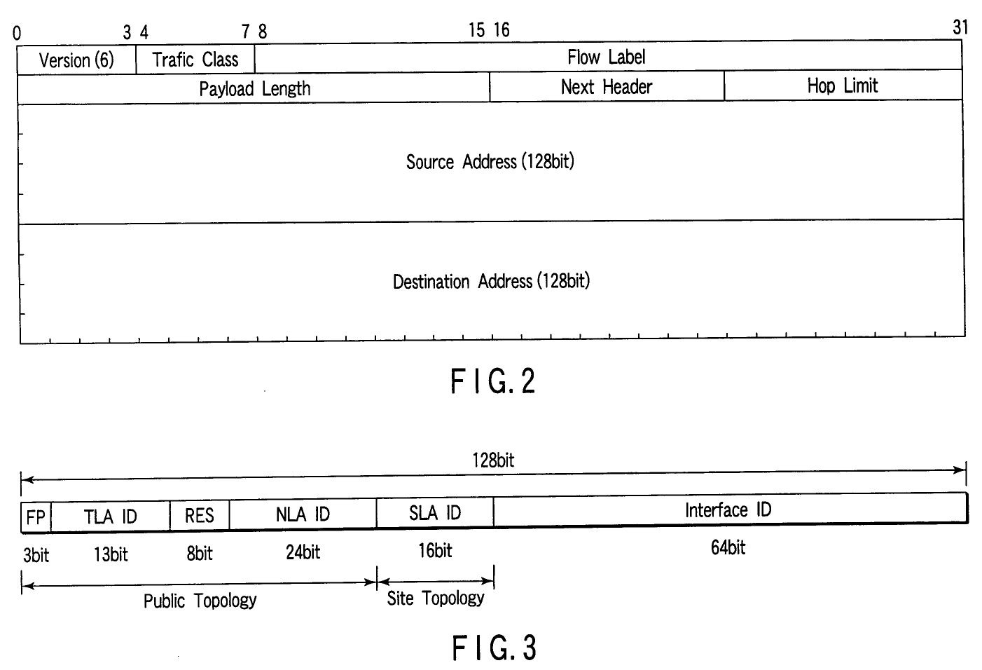

FIG. 2 shows the structure of an IPv6 packet header, and the structure of the header will be described below.

As shown in FIG. 2, the header of an IPv6 packet that the first embodiment adopts contains version (Version(6)), traffic class (Traffic Class), flow label (Flow Label), payload length (Payload Length), next header ID (Next Header), hop limit (Hop Limit), source IPv6 address (Source Address), and destination IPv6 address (Destinations Address).

Of these fields, the traffic class field is used to improve the communication efficiency. The flow label field is used to discriminate a packet expressed by priority using a predetermined unit. The payload length field indicates the length of data which follows the IPv6 header. The next header ID field indicates the type of the next header. Furthermore, the hop limit field used to limit the number of times that a packet can pass through a node such as a router or the like. In addition, 128 bits are assigned to each of the source and destination IPv6 address fields.

An IPv6 packet with such header is transferred on the network in accordance with the destination IPv6 address. At this time, the receiving side can specify the source on the basis of the source IPv6 address contained in the header.

The IPv6 address structure will be described in detail below.

FIG. 3 shows the address structure of an IPv6 aggregatable global unicast address (RFC2374), and that address structure will be described below.

As shown in FIG. 3, an address of the IPv6 aggregatable global unicast address consists of FP (Format Prefix) associated with an address type, TLA ID (Top-Level Aggregation Identifier) as a top-level aggregation identifier, RES (Reserved for future use), NLA-ID (Next-Level Aggregation Identifier) as a next-level aggregation identifier, SLA ID (Site-Level Aggregation Identifier) as a site-level aggregation identifier, and interface ID.

The upper 64 bits which contain public and site topologies are an address that represents a network, The interface ID in the lower 64 bits is an identifier used to identify an interface on the network designated by the network address. This interface ID can also be generated from a MAC (media access control) address. This MAC address guarantees generation of a unique value by combining a manufacturer identifier and device identifier. Hence, when the interface ID is generated based on the MAC address value, a unique IPv6 address can be generated.

In this manner, the interface ID in the IPv6 address is a value unique to the interface (device). Therefore, even when the IPv6 address has changed upon connection to another network, the network address need only be changed. That is, since the interface ID is always fixed, a unique interface (unique device) can be specified with reference to the interface ID of the IPv6 address.

Note that the 64-bit interface ID is used to identify each individual terminal in the network, and is generated without duplication. For this purpose, IPv6 adopts a system called “EUI-64”.

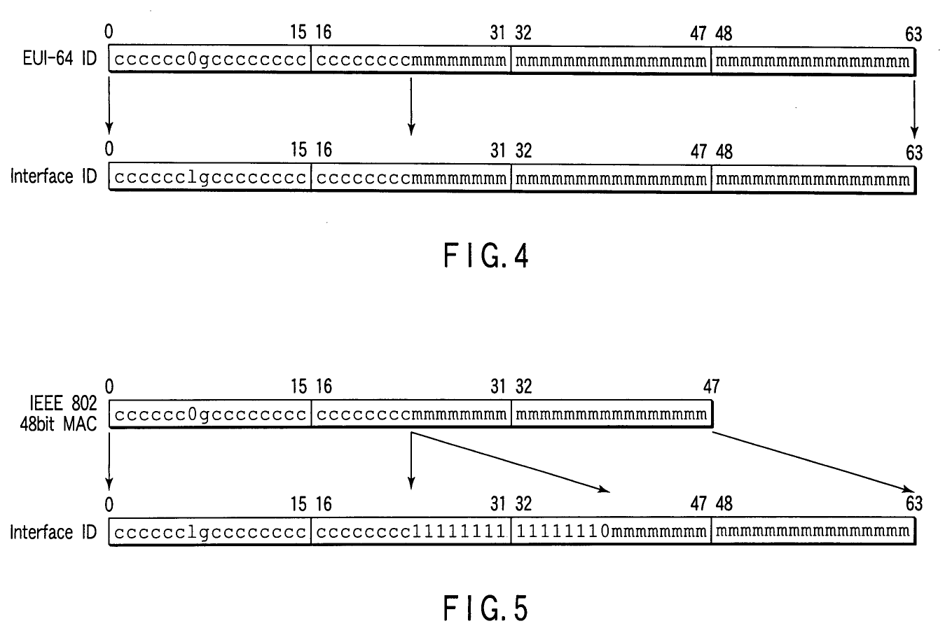

A process for generating the interface ID from this EUI-64 (which is a 64-bit ID used to uniquely identify a device and is an address system standardized by IEEE) ID is as shown in FIG. 4. In FIG. 4, “c” s indicate a manufacturer identifier, and “m”s indicate a device identifier. Furthermore, a process for generating the interface ID from IEEE802 (Ethernet) 48-bit MAC is as shown in FIG. 5. In FIG. 5, “c”s indicate a manufacturer identifier, and “m”s indicate a device identifier. Since these generation processes are state-of-the-art techniques, a detailed description thereof will be omitted.

Filtering of a router based on the IPv6 address adopted by the IPv6 network system according to the first embodiment of the present invention will be described below.

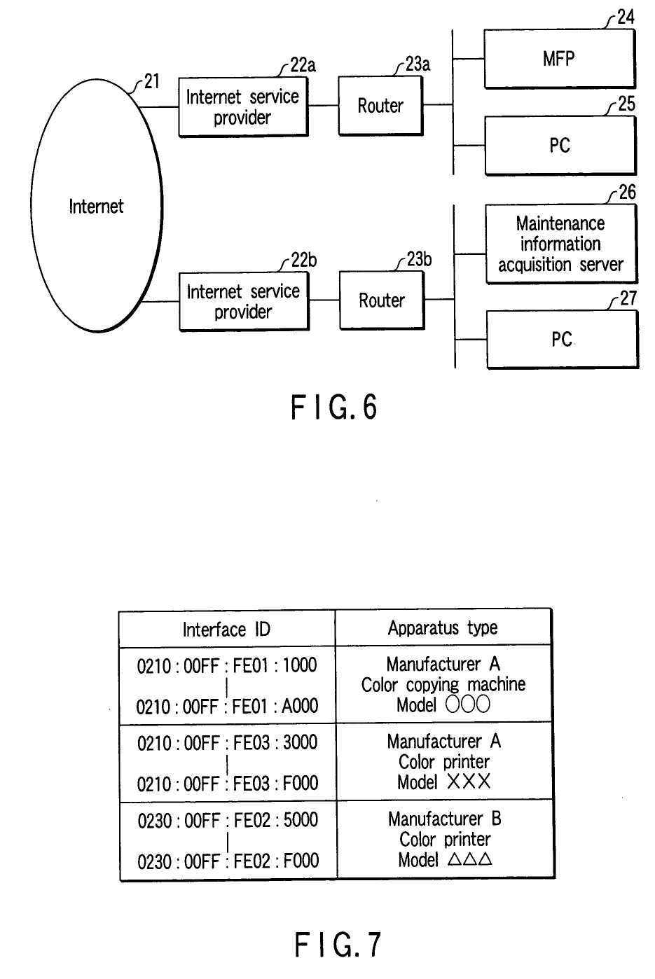

FIG. 6 shows the connection relationship among various devices 24 and 25 on a user network, and a maintenance information acquisition server 26 on a network of a maintenance service provider via an Internet 21, and the connection relationship will be explained below.

Assume that a device which is to undergo maintenance is only an MFP apparatus 24 on the user network, and a PC 25 connected to that network is precluded. Likewise, a PC 27 connected to the same network as the maintenance information acquisition server 26 of the maintenance service provider is independent of a maintenance service.

Under such assumption, when the MFP apparatus 24 and maintenance information acquisition server 26 exchange maintenance information via the Internet 21, the system according to the first embodiment prevents data from the PCs 25 and 27 which are independent of the maintenance service from flowing on the Internet 21, and prevents data on the Internet 21, which are independent of the maintenance service, from flowing into the user network and the network of the maintenance service provider.

More specifically, in the first embodiment, upon establishing connection between the Internet 21 and the user network or the network of the maintenance service provider, the destination and source IPv6 addresses in each IP packet are checked. A device that serves as a communication partner is specified based on the interface ID so as to control permission/inhibition of communications with the Internet 21, thereby filtering IP packets.

In practice, filtering based on the interface ID is made using a filtering setup table shown in, e.g., FIG. 7.

The filtering setup table shown in FIG. 7 stores interface IDs and device types in association with each other, as shown in FIG. 7.

With this filtering setup table, a manufacturer and individual device can be identified from the interface ID. Hence, when the range of interface IDs or device IDs of specific devices is designated to include all and some devices of identical models, filter setups which are grouped for respective device can be made.

In the example of FIG. 7, the interface IDs of a color copying machine (model ◯◯◯) and color printer (model ×××) of manufacturer A, and a color printer (model ΔΔΔ) of manufacturer B are set as filter conditions. Only an IPv6 packet whose source address matches the filter condition is permitted to be transmitted onto the Internet 21. Furthermore, the interface ID of the maintenance information acquisition server 26 of the maintenance service provider via the Internet 21 can be used as a destination condition. In this case, more secure filtering can be implemented, and outflow of unwanted data onto the Internet 21 can be prevented.

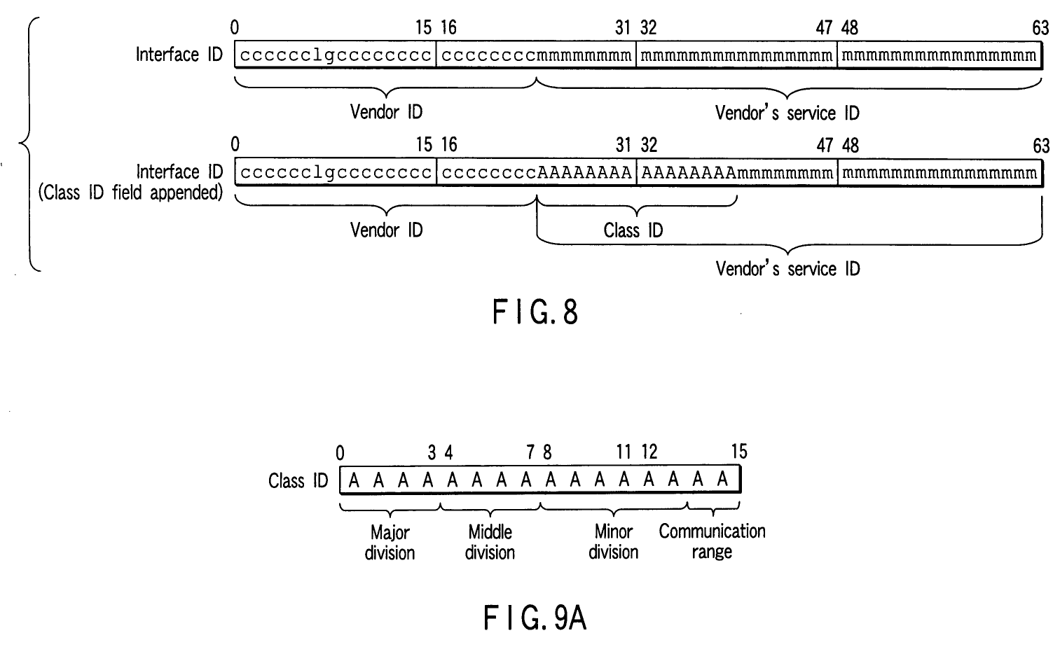

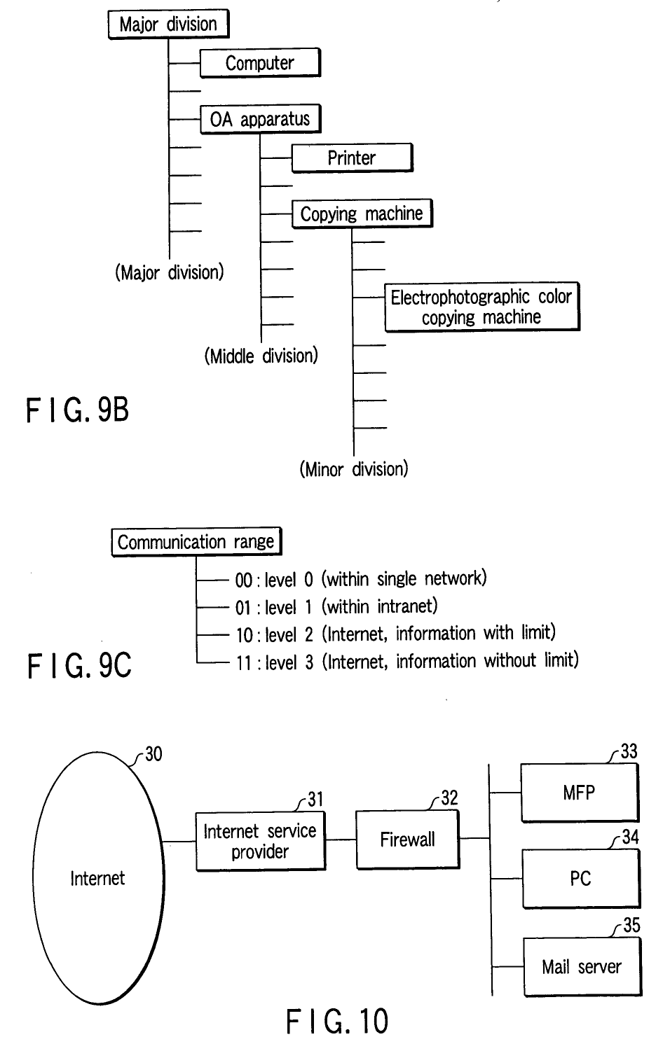

A process for appending an identifier which indicates class information such as a device attribute, communication content type, and the like to the interface ID, and executing filtering based on the identifier indicating the class information will be described in detail below with reference to FIGS. 8 and 9.

FIG. 8 shows an example in which some bits of a vendor's service ID (device identifier) of the interface ID are used as a class ID, and this example will be described below. In this example, a vendor ID is assigned to the upper 24 bits of the interface ID, and a vendor's service ID is assigned to lower 40 bits. Upon appending a class ID field, a class ID is assigned to the upper 16 bits of the vendor's service ID.

FIGS. 9A to 9C show an example of definition of bit fields that indicate hierarchical class information and a communication content type in a bit field of the class ID, and that example will be explained below.

FIG. 9A shows the layers of the class ID. That is, in this example, the class ID has a major division, middle division, minor division, and communication range.

As shown in FIG. 9B, generic concepts such as a computer, OA apparatus, and the like belong to the major division, middle concepts such as a printer, copying machine, and the like included in, e.g., the OA apparatus belong to the middle division, and specific concepts such as an electrophotographic color copying machine and the like included in, e.g., the copying machine belong to the minor division.

Furthermore, as shown in FIG. 9C, the communication range is defined as:

00: level 0 (within single network)

01: level 1 (within intranet)

10: level 2 (Internet, information with limit)

11: level 3 (Internet, information without limit)

Since the class ID is defined independently of the device identifier, a device to be filtered can be easily specified. Furthermore, filter condition setups can be simplified compared to those using the device identifier alone.

Note that, for example, a filter condition can be set as:

vender ID=manufacturer A, product class=printer or copying machine, communication type=Internet transmission permitted

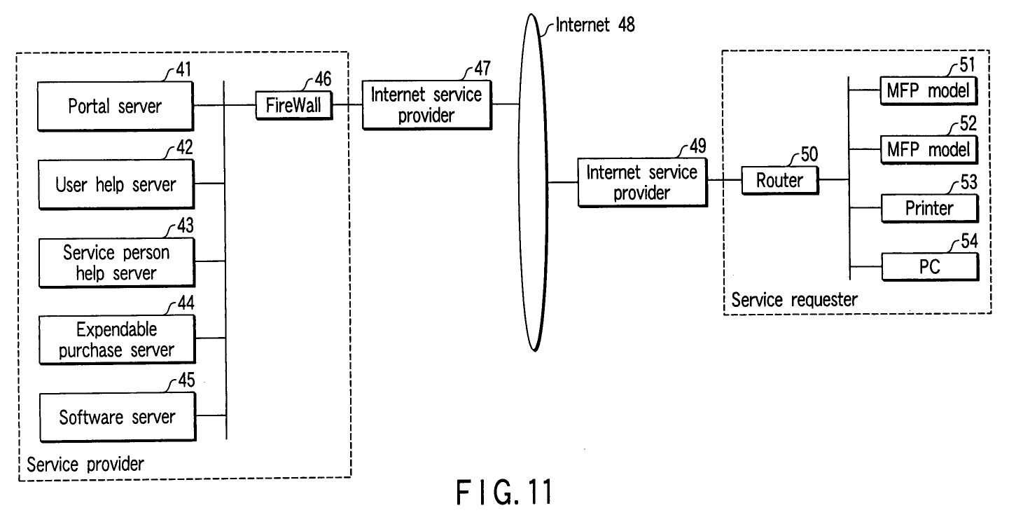

A use method which adopts the interface ID as a use condition for generic services according to the first embodiment will be described in detail below with reference to FIG. 10.

In the example shown in FIG. 10, an MFP apparatus 33, PC 34, and mail server 35 are connected to a server 31 of an Internet service provider via a firewall 32. These apparatuses can freely make communications via an Internet 30 by a service provided by the Internet service provider.

In this arrangement, when information required for maintenance of the MFP apparatus 33 is to be transmitted from a corporate network via the Internet 30, whether or not the MFP apparatus is a device whose maintenance information is to be transmitted onto the Internet 30 is determined on the basis of the interface ID. In this way, an e-mail protocol (e.g., SMTP), Web access protocol (e.g., HTTP), and the like as generic services can control permission/inhibition of data transmission onto the Internet 30.

Furthermore, when a condition based on class information using the vendor's service ID (device identifier) or class ID of the interface ID is given to generic services, the generic services can check the IPv6 address of a request source to control available functions of the request source that matches the condition.

(Second Embodiment)

An IPv6 network system according to the second embodiment of the present invention, which dynamically switches transmission information of a server that provides a service in accordance with the interface ID of a service request node, will be described in detail below.

Note that the arrangement of the IPv6 network system according to the second embodiment of the present invention is as shown in, e.g., FIG. 11.

That is, on the service requester side, MFP apparatuses 51 and 52, a printer 53, and a PC 54 are connected to a server 49 of an Internet service provider via a router 50 to be free to make communications. These apparatuses can make communications via an Internet 48 by a service provided by the Internet service provider.

On the service provider side, a portal server 41, user help server 42, service person help server 43, expendable purchase server 44, and software server 45 are connected to a server 47 of an Internet service provider via a firewall 46 to be free to make communications. These apparatuses can make communications via the Internet 48 by a service provided by the Internet service provider.

In the system with the above arrangement, devices which are connected to a corporate LAN or SOHO or home LAN as the service requester, i.e., the MFP apparatuses 51 and 52, printer 53, and PC 54 in FIG. 11, have IDs unique to devices in interface IDs of their IPv6 addresses. In this example, the MFP apparatuses 51 and 52 connected to the LAN of the service requester are different models, and have different detailed operation instructions and helps to be provided to the user, and different types of expendables such as toners and the like.

Assume that the MFP apparatuses 51 and 52 access a user support page provided by the service provider using their Web browser functions. Access to the user support page uses a single address (URL) independently of the models of the MFP apparatuses 51 and 52.

A Web page acquisition request using this address is accepted by a representative Web server, i.e., the portal server 41 in FIG. 11. This portal server 41 can specify the IP address and port number of each MFP apparatus which issued the Web page acquisition request on the basis of connection information, i.e., socket information, of TCP/IP communications. In the IP address of IPv6, since the interface ID contained in that IP address has a global unique value, two different apparatuses which make communications can be recognized individually. Therefore, the interface ID can specify not only a model of the MFP apparatus but also a specific one of apparatuses of an identical model.

Note that it is also possible to specify a model by an individual identification number (number assigned to each individual apparatus). However, when the interface ID independently contains information used to specify a model and information used to specify an individual, the model of the apparatus can be specified with reference to only the information used to specify a model in the interface ID.

The portal server 41 as a representative Web server specifies a device which issued the Web page acquisition request by the aforementioned method, and can send information corresponding to the device to a target apparatus. Also, in response to an acquisition request from an unexpected device, a message that advises accordingly can be sent or that acquisition request can be denied. Therefore, an apparatus or user that issues an information acquisition request can automatically select and acquire information suited to the apparatus independently of the model and detailed individual information of the apparatus.

As a practical application example, in response to support Web access from a given MFP apparatus, a purchase window of expendables available for that MFP apparatus, and a detailed help window can be accessed without inputting model information or designating different URLs depending on models.

In addition to user access, detailed services and maintenance information for a service direction can be quickly accessed by simple operations from the customer side.

Note that the second embodiment described above has exemplified acquisition of a Web page, but the present invention is not limited to Web services exploiting HTTP. That is, all client and server applications that exploit TCP/IP communications can make individual identification using the interface IDs, and can dynamically change service contents using the individual identification information.

(Third Embodiment)

An IPv6 network system according to the third embodiment of the present invention, which is characterized in that a representative server executes data management and data processes in accordance with the interface ID of a service request node, will be described in detail below.

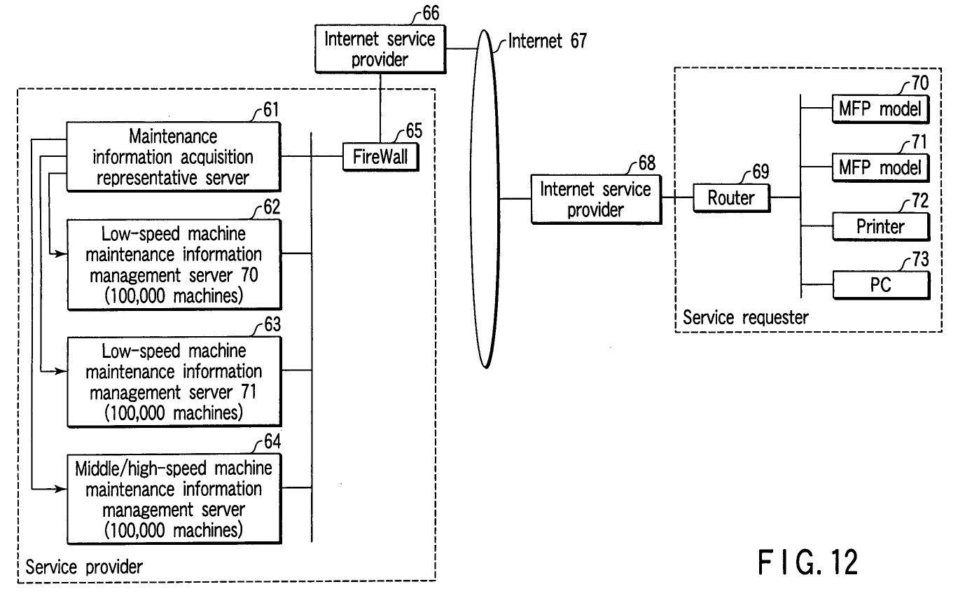

Note that the arrangement of the IPv6 network system according to the third embodiment of the present invention is as shown in, e.g., FIG. 12.

That is, on the service requester side, MFP apparatuses 70 and 71, a printer 72, and a PC 73 are connected to a server 68 of an Internet service provider via a router 69 to be free to make communications. These apparatuses can make communications via an Internet 67 by a service provided by the Internet service provider.

On the other hand, on the service provider side, a maintenance information acquisition representative server 61, low-speed machine maintenance information management server 62, low-speed machine maintenance information management server 63, and middle/high-speed machine maintenance information management server 64 are connected to a server 66 of an Internet service provider via a firewall 65 to be free to make communications. These apparatuses can make communications via the Internet 67 by a service provided by the Internet service provider.

In such arrangement, in this system, devices which are connected to a corporate LAN or SOHO or home LAN as the service requester, i.e., the MFP apparatuses 70 and 71, printer 72, and PC 73 in FIG. 12, have IDs unique to devices in interface IDs of their IPv6 addresses. Note that the MFP apparatuses 70 and 71 connected to the LAN of the service requester are different models, and have different kinds of information about expendables such as toners, wearing parts, parts that deteriorate along with time, and the like, and different kinds of log information such as paper jam, abnormal operations, and the like, which occur in the apparatuses, for respective models. The MFP apparatuses 70 and 71 transmit information of expendables and log information such as paper jam, abnormal operations, and the like, which occur in the apparatuses, to the maintenance information acquisition representative server 61 at predetermined timings (consumption amounts of expendables or the number of processed pages, use time, immediately after occurrence of any abnormal operation, predetermined schedule, or the like).

Assume that the system of this example must support 20,000 MFP apparatuses 70 as high-speed machines, and 200,000 MFP apparatuses 71 as low-speed machines. Under such assumption, the MFP apparatuses 70 and 71 transmit their maintenance information to the maintenance information acquisition representative server 61 via TCP/IP communications independently of models. The maintenance information acquisition representative server 61 can specify the IP address and port number of a device which issued the transmission request of the maintenance information by connection information (socket information) of TCP/IP communications.

In the IP address of IPv6, since the interface ID contained in that IP address has a global unique value, two different apparatuses which make communications can be recognized individually. Therefore, in this example, the interface ID can specify not only the model of the apparatus but also a specific one of apparatuses of an identical model.

Note that it is also possible to specify a model by an individual identification number (number assigned to each individual apparatus). However, when the interface ID independently contains information used to specify a model and information used to specify an individual, the model of the apparatus can be specified with reference to only the information used to specify a model in the interface ID.

The maintenance information acquisition representative server 61 specifies devices which issued transmission requests of maintenance information by the aforementioned methods, and distributes requests to a plurality of servers assigned to respective processes, thus efficiently processing the requests.

In this example, in response to a request from an unexpected device, a message that advises accordingly can be sent or an acquisition request can be denied.

The apparatus or user that issues a transmission request of maintenance information can automatically make the specific maintenance information acquisition representative server 61 process required information independently of the model and detailed individual information of the apparatus.

The third embodiment described above has exemplified transmission of maintenance information. However, all client and server applications that exploit TCP/IP communications can make individual identification using the interface IDs, and can appropriately switch servers which are used to actually process services using the individual identification information upon providing various services, as a matter of course.

(Fourth Embodiment)

An IPv6 network system according to the fourth embodiment of the present invention, which is characterized in that a representative server that provides a service in accordance with the interface ID of a service request node notifies the service request node of the request destination of a server that actually executes processes so as to provide a service from an appropriate server, will be described below.

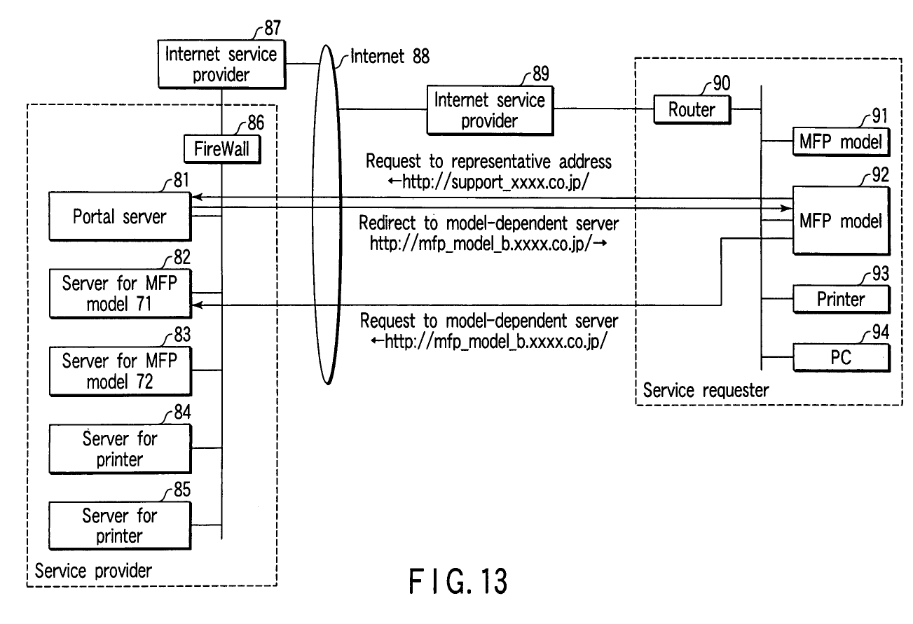

Note that the arrangement of the IPv6 network system according to the fourth embodiment of the present invention is as shown in, e.g., FIG. 13.

That is, on the service requester side, MFP apparatuses 91 and 92, a printer 93, and a PC 94 are connected to a server 89 of an Internet service provider via a router 90 to be free to make communications. These apparatuses can make communications via an Internet 88 by a service provided by the Internet service provider.

On the other hand, on the service provider side, a portal server 81, server 82 for the MFP apparatus 91, server 83 for the MFP apparatus 92, server 84 for the printer, and server 85 for the PC are connected to a server 87 of an Internet service provider via a firewall 86 to be free to make communications. These apparatuses can make communications via the Internet 88 by a service provided by the Internet service provider.

In this arrangement, devices which are connected to a corporate LAN or SOHO or home LAN as the service requester, i.e., the MFP apparatuses 91 and 92, printer 93, and PC 94 in FIG. 13, have IDs unique to devices in the interface IDs of their IPv6 addresses. In this system, the MFP apparatuses 91 and 92 connected to the LAN of the service requester are different models, and have different detailed operation instructions and helps to be provided to the user, and different types of expendables such as toners and the like.

Assume that the MFP apparatuses 91 and 92 access a user support page provided by the service provider using their Web browser functions. Access to the user support page uses a single address (URL) independently of models of the MFP apparatuses.

A Web page acquisition request using that address is accepted by a representative Web server, i.e., the portal server 81. This portal server 81 can specify the IP address and port number of each MFP apparatus which issued the Web page acquisition request on the basis of connection information (socket information) of TCP/IP communications. In the IP address of IPv6, since the interface ID contained in that IP address has a global unique value, two different apparatuses which make communications can be recognized individually.

Therefore, in this system, the interface ID can specify not only the model of the MFP apparatus but also a specific one of apparatuses of an identical model.

Note that it is also possible to specify a model by an individual identification number (number assigned to each individual apparatus). However, when the interface ID independently contains information used to specify a model and information used to specify an individual, the model of the apparatus can be specified with reference to only the information used to specify a model in the interface ID.

The portal server 81 as a representative Web server specifies a device which issued the Web page acquisition request by the aforementioned method, and can send the location of a server and information that provides information corresponding to the device to the apparatus that issued the Web page acquisition request. Also, in response to an acquisition request from an unexpected device, a message that advises accordingly can be sent or that acquisition request can be denied.

More specifically, in this system, acquisition of a Web page by means of HTTP will be exemplified. The portal server 81 specifies the model of an MFP as the request source using its interface ID in response to a Web page acquisition request to the representative address.

The apparatus or user that issues an information acquisition request can automatically select or acquire information suited to the apparatus independently of the model and detailed individual information of the apparatus by redirecting the address (URL) of a Web page corresponding to the MFP apparatus as the request source to include the link to the destination.

Note that redirecting means an operation for automatically switching an acquisition destination by describing the URL of a destination in Web page information.

As a practical application example, in response to support Web access from a given MFP apparatus, a purchase window of expendables available for that MFP apparatus, and a detailed help window can be accessed without inputting model information or designating different URLs depending on models. In addition to user access, detailed services and maintenance information for services can be quickly accessed by simple operations from the customer side.

In this example, acquisition of a Web page has been exemplified, but the present invention is not limited to Web services exploiting HTTP. That is, all client and server applications that exploit TCP/IP communications can make individual identification using the interface IDs. Then, service contents can be dynamically switched by exploiting the individual identification information, as a matter of course. Therefore, since the interface ID contains class information indicating an attribute of a device itself, the attribute of a device that makes communications can be detected by analyzing the interface ID of the IPv6 address. Based on that attribute information, a filtering process such as permission/inhibition of data transfer and the like can be implemented.

Compared to the conventional method that checks the full IP address to specify a device upon filtering, since only attribute information (manufacturer, model, and the like) is checked, the loads on the processes required upon filtering, and setup and management works can be reduced.

As described above, according to the first to fourth embodiments of the present invention, the following effects are provided. That is, the IPv6 address has a 128-bit length, in which the network address can be assigned to the former 64 bits, and the interface ID can be assigned to the latter 64 bits. Hence, the interface ID of a given host remains unchanged independently of the networks to which the host is connected.

That is, if a specific host must undergo filtering, the interface ID which is contained in the IPv6 address and is a value unique to that host can be used as a filtering condition.

Even when a given host need be connected to another network, its interface ID remains unchanged. Hence, the same filtering condition can be used for the gateway.

Furthermore, when the interface ID contains attribute information such as the type of device, type of communication contents, and the like, and each model or the type of communication contents in a given model is used as a condition in place of that unique to a host, filtering can be done for respective groups.

Also, the interface ID can be used as a use condition for generic services. For example, when information required for maintenance of an apparatus is transmitted from a corporate network via the Internet, whether or not maintenance information of a given apparatus is to be transmitted onto the Internet is determined using the interface ID.

In this way, an e-mail protocol (e.g., SMTP), Web access protocol (e.g., HTTP), and the like as generic services can control permission/inhibition of data transmission onto the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gateway apparatus which identifies source and destination addresses in an IPv6 header of an IP packet upon transferring an IP packet between networks, and controls, when interface IDs in the source and destination addresses match a pre-set condition, permission/inhibition of transfer between the networks, which are determined in correspondence with the condition.

2. The gateway apparatus according to claim 1, wherein the gateway apparatus controls permission/inhibition of transfer when the interface IDs match at least one specific interface ID or an interface ID range of a predetermined condition.

3. The gateway apparatus according to claim 1, wherein the gateway apparatus controls permission/inhibition of transfer when the interface IDs match a specific value or a specific range of a specific bit field in at least one specific interface ID of a predetermined condition.

4. An IPv6 network system comprising:
an apparatus which is connected to an IPv6 network and has an IPv6 address; and
a gateway apparatus which identifies source and destination addresses in an IPv6 header of an IP packet upon transferring an IP packet between networks, and controls, when interface IDs in the source and destination addresses match a pre-set condition, permission/inhibition of transfer between the networks, which are determined in correspondence with the condition.

5. The IPv6 network system according to claim 4, wherein the gateway apparatus controls permission/inhibition of transfer when the interface IDs match at least one specific interface ID or an interface ID range of a predetermined condition.

6. The IPv6 network system according to claim 4, wherein the gateway aapparatus controls permission/inhibition of transfer when the interface IDs match a specific value or a specific range of a specific bit field in at least one specific interface ID of a predetermined condition.

7. The IPv6 network system according to claim 4, wherein an interface ID in an IP address of the apparatus which has the IPv6 address contains class information, that indicates a type of that apparatus, a type of communication contents, and the like, independently of information used to individually identify the apparatus, and
the gateway apparatus controls permission/inhibition of transfer when class information in the interface ID in the source and destination addresses matches the pre-set condition.

8. The IPv6 network system according to claim 7, wherein the gateway apparatus controls permission/inhibition of transfer under another condition that the information used to individually identify the apparatus in the interface ID matches at least one specific value or a specific range.

9. The IPv6 network system according to claim 8, wherein the apparatus has a plurality of IPv6 addresses which contain different types of class information depending on functions, types of communication contents, and the like.

10. An IPv6 network system comprising:
an apparatus which is connected to an IPv6 network and has an IPv6 address, in which an interface ID contains class information, that indicates a type of that apparatus, a type of communication contents, and the like, independently of information used to individually identify the apparatus;
a gateway apparatus for connecting a plurality of IPv6 networks; and
a server which identifies source and destination addresses in an IPv6 header of an IP packet upon generation of a service request from the apparatus using the IP packet, and controls, when class information in the interface IDs in the source and destination addresses match a pre-set condition, a change in function to a service corresponding to the condition or permission/inhibition of the service.

11. The IPv6 network system according to claim 10, wherein the server controls permission/inhibition under another condition that the information used to individually identify the apparatus in the interface ID matches at least one specific value or a predetermined range.

12. An IPv6 network system comprising:
an apparatus which is connected to an IPv6 network and has an IPv6 address, in which an interface ID contains class information, that indicates a type of that apparatus, a type of communication contents, and the like, independently of information used to individually identify the apparatus;
a gateway apparatus for connecting a plurality of IPv6 networks; and
a server which identifies a source address in an IPv6 header of an IP packet upon generation of a service request from the apparatus using the IP packet, and dynamically switches service contents in accordance with interface ID information in the source address.

13. The IPV6 network system according to claim 12, wherein the server dynamically switches the service contents under a condition that the information used to individually identify the apparatus in the interface ID in the IP address of the apparatus having the IPv6 address matches at least one specific value or a predetermined range.

14. The IPV6 network system according to claim 12, wherein the interface ID contains class information, that indicates a type of the apparatus, a type of communication contents, and the like, independently of information used to individually identify the apparatus, and
the server dynamically switches the service contents under a condition that the class information in the interface ID matches a pre-set condition, and the information used to individually identify the apparatus matches at least one specific value or a predetermined range.

15. The IPV6 network system according to claim 12, wherein upon generation of a service request from the apparatus using an IP packet, the server identifies a source address in an IPv6 header of the IP packet, accepts the service request in accordance with interface ID information in the source address, and distributes at least some of processes to at least one other server.

16. The IPV6 network system according to claim 12, wherein the server accepts the service request, and distributes at least some of processes to at least one other server under a condition that the information used to individually identify the apparatus in the interface ID contained in the IP address of the apparatus having the IPv6 address matches at least one specific value or a predetermined range.

17. The IPV6 network system according to claim 12, wherein the interface ID contains class information, that indicates a type of the apparatus, a type of communication contents, and the like, independently of information used to individually identify the apparatus, and
the server dynamically accepts the service request, and distributes at least some of processes to at least one other server under a condition that the class information in the interface ID matches a pre-set condition, and the information used to individually identify the apparatus matches at least one specific value or a predetermined range.

18. The IPV6 network system according to claim 12, wherein upon generation of a service request from the apparatus using an IP packet, the server identifies a source address in an IPv6 header of the IP packet, accepts the service request in accordance with interface ID information in the source address, and notifies a service request source of a request destination of a server that actually provides a service.

19. The IPV6 network system according to claim 12, wherein the server accepts the service request, and notifies a service request source of a request destination of a server that actually provides a service under a condition that the information used to individually identify the apparatus in the interface ID contained in the IP address of the apparatus having the IPv6 address matches at least one specific value or a predetermined range.

20. The IPV6 network system according to claim 12, wherein the interface ID contains class information, that indicates a type of the apparatus, a type of communication contents, and the like, independently of information used to individually identify the apparatus, and
the server dynamically accepts the service request, and notifies a service request source of a request destination of a server that actually provides a service under a condition that the class information in the interface ID matches a pre-set condition, and the information used to individually identify the apparatus matches at least one specific value or a predetermined range.
